(19) United States
(12) Patent Application Publication
(10) Pub. No.: US 2004/0003998 A1
(43) Pub. Date: Jan. 8, 2004

(54) Electrophoresis separation apparatus

(75) Inventors: Chih-Wei Ho, Miaoli (TW); Chung-Fan Chiou, Hsinchu (TW); Bor-Iuan Jan, Pingtung (TW); Chien-Tsung Wu, Taichung (TW); Jian-Je Jian, Taipei (TW)

Correspondence Address: SUGHRUE MION, PLLC, 2100 PENNSYLVANIA AVENUE, N.W., WASHINGTON, DC, 20037, US

(73) Assignee: INDUSTRIAL TECHNOLOGY RESEARCH INSTITUTE

(21) Appl. No.: 10/318,013

(22) Filed: Dec. 13, 2002

(30) Foreign Application Priority Data
Jul. 2, 2002 (TW) 91114597

(51) Int. Cl. G01N 27/27

(52) U.S. Cl. 204/603; 204/620

(57) ABSTRACT

An electrophoresis separation apparatus. The electrophoresis separation apparatus detects samples, and comprises a main portion, a cartridge, and a sensor. The main portion includes a receiving portion, and controls the detection of the samples. The cartridge is disposed in the receiving portion of the main portion in a detachable manner, and includes a detection column.

### BACKGROUND OF THE INVENTION

1. Field of the Invention

The invention relates to an electrophoresis separation apparatus; in particular, to an electrophoresis separation apparatus with a detachable cartridge.

2. Description of the Related Art

The value of electrophoresis in biochemistry has been recognized for some time in the analysis, for example, of proteins in serum as well as other body fluids. FIG. 1 shows a conventional gel electrophoresis apparatus 10. The apparatus 10 comprises a separation tank 11, and a power supply 12 electrically coupled to the separation tank 11. During analysis, a sample is applied near one edge of a layer of gelatin carried on a flexible sheet, usually called a “gel” 13. The gel 13 is disposed in the separation tank 11, and is electrophoresis by the power supply 12, stained and the density of the resulting pattern is measured to reveal the proteins contained in the sample.

Although gel electrophoresis is relatively inexpensive in terms of the supplies and equipment required to perform sample analyses, the technique requires skilled technicians and is time consuming, effectively resulting in a high price per test and limiting the number of tests that can be performed using the technique.

Efforts have been made to automate electrophoresis in laboratories. For example, capillary electrophoresis is a more recent development and can be used to perform the type of electrophoresis separations presently performed with gels.

Automated forms of capillary electrophoresis analyzers are known in the art. For example, FIG. 2 shows a conventional capillary electrophoresis analyzer 20 described in U.S. Pat. No. 5,560,811. An electrophoresis separation plate 21 has a plurality of sample wells 22 at one end and a common buffer reservoir 23 at the other end. A first master electrode 25 is electrically connected to a cell electrode 26 in the sample wells 22. A second master electrode 27 is in the common buffer reservoir 23. Capillary electrophoresis columns 28 are mounted in the plate 21 so that there is electrical communication between the first master electrode 25 by way of the capillary electrophoresis column 28 when the sample wells 22 and the reservoir 23 are filled with electrically conductive liquid. In operation, current between the master electrodes permits electrophoresis of the sample from the sample well 22 to the reservoir 23.

Other automated capillary electrophoresis apparatuses are described in U.S. Pat. No. 6,132,582, U.S. Pat. No. 5,885,430, U.S. Pat. No. 6,118,127, U.S. Pat. No. 5,413,686.

None of the automated analyzers described, however, are suitable for routine clinical laboratory applications. Each requires considerable manual manipulation despite their automated nature, such as preparation and placement of individual sample and buffer vials onto the analyzer, programming for the various analytical routines, and the like. Because only one sample can undergo electrophoresis and detection during each analysis cycle of the analyzers, the number of samples per unit time, or throughput, is severely restricted compared to the needs of most routine clinical laboratory work.

### SUMMARY OF THE INVENTION

In order to address the disadvantages of the aforementioned electrophoresis apparatus, the invention provides an electrophoresis separation apparatus with a detachable cartridge to enhance convenience during detection.

Another purpose of this invention is to provide an electrophoresis separation apparatus with a replaceable hand-held cartridge to prevent samples from intermixing.

Accordingly, the invention provides an electrophoresis separation apparatus for detecting samples. The apparatus comprises a main portion, a cartridge, and a sensor. The main portion includes a receiving portion, and controls the detection of the samples. The cartridge is disposed in the receiving portion of the main portion in a detachable manner, and includes a detection column. The detection column includes a first end and a second end, and has a first voltage at the first end and a second voltage at the second end. The sample is attached to the second end of the detection column, and moves from the second end to the first end through the detection column by a voltage differential between the first voltage and the second voltage. The sensor is disposed in the main portion, and detects a movement of the sample in the detection column.

In a preferred embodiment, the cartridge further comprises a body and a base. The body includes the detection column for attaching the sample. The base is combined with the body, and includes a hole for receiving the detection column of the body.

In another preferred embodiment, the main portion defines a slot communicating with the receiving portion to guide the cartridge into the receiving portion.

Furthermore, the main portion defines a first concave portion communicating with the slot, and the cartridge includes a first protrusion corresponding to the first concave portion. The cartridge moves smoothly in the slot by the first protrusion's insertion into the first concave portion.

In another preferred embodiment, the main portion includes a second protrusion in the receiving portion, and the cartridge defines a second concave portion corresponding to the second protrusion. The cartridge moves smoothly in the receiving portion by the second protrusion's insertion into the second concave portion.

In another preferred embodiment, the main portion includes a first conductive portion and a second conductive portion in the receiving portion, and the cartridge includes a third conductive portion corresponding to the first conductive portion, and a fourth conductive portion corresponding to the second conductive portion. The third conductive portion is coupled to the first conductive portion, and the fourth conductive portion is coupled to the second conductive portion so that the detection column has the first voltage and the second voltage.

In another preferred embodiment, the main portion further comprises a power supply, a controller, an input panel, and a display. The power supply is coupled to the first conductive portion and the second conductive portion, and provides the first voltage and the second voltage to the detection column via the first conductive portion and the second conductive portion. The controller is coupled to the power supply to control the power supply. The input panel is coupled to the controller, and inputs data to be analyzed. The display is coupled to the controller, and displays the data.

In another preferred embodiment, the electrophoresis separation apparatus comprises a power supply, a computer, and a robot arm. The power supply is coupled to the main portion, and provides the first voltage and the second voltage to the detection column. The computer is coupled to the main portion, and controls the power supply and inputs and displays data to be analyzed. The robot arm is coupled to the main portion, and moves the cartridge to a predetermined position.

In another preferred embodiment, the cartridge includes a standard column for comparison with the detection column.

In another preferred embodiment, a macromolecular material is added into the detection column to separate the sample. It is understood that the macromolecular material can be natural or artificial.

It is also understood that a liquid, gel, or solid material can be added into the detection column to separate the sample. The solid material may be porous.

In another preferred embodiment, the sensor may be an optical sensor, such as a photodiode or a PMT corresponding to the receiving portion.

It is understood that a labeling reagent can be attached to the sample to assist the sensor in detecting the sample. The labeling reagent comprises fluorescent molecules, nanometer-scale particles, or light-absorbent molecules.

In another preferred embodiment, the detection column includes a convex lens therein to assist the sensor in detecting the sample.

### BRIEF DESCRIPTION OF THE DRAWINGS

The invention is hereinafter described in detail with reference to the accompanying drawings in which:

FIG. 1 is a schematic view of a conventional gel electrophoresis apparatus;

FIG. 2 is a schematic view of a conventional capillary electrophoresis analyzer as described in U.S. Pat. No. 5,560,811;

FIG. 3a and FIG. 3b are schematic views of an electrophoresis separation apparatus as disclosed in this invention;

FIG. 3c is a partial front view of a main portion in FIG. 3a;

FIG. 3d is a schematic view of a variant embodiment of an electrophoresis separation apparatus as disclosed in this invention;

FIG. 4a is an exploded view of a cartridge in FIG. 3a;

FIG. 4b is a schematic view of a detection column in FIG. 4a; and

FIG. 5a, FIG. 5b, FIG. 5c and FIG. 5d are schematic views that show the electrophoresis separation apparatus, shown in FIG. 3a, performs the detection of the samples.

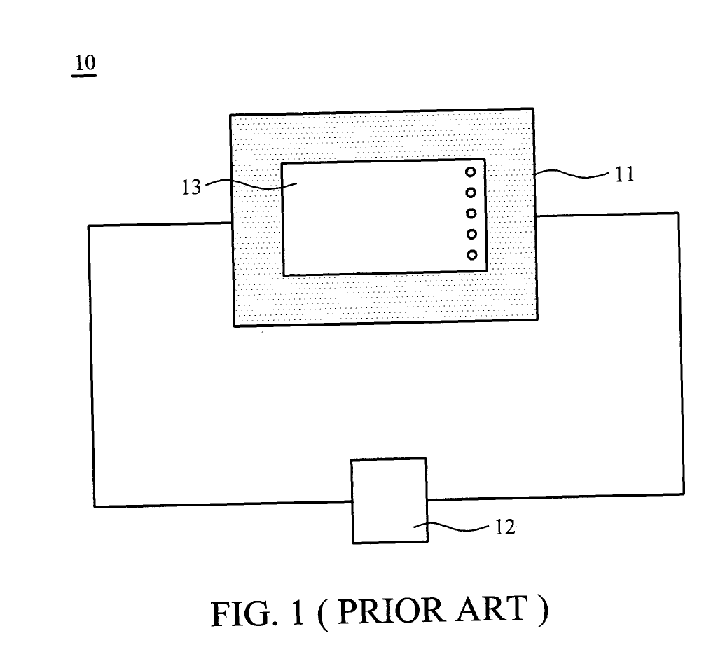

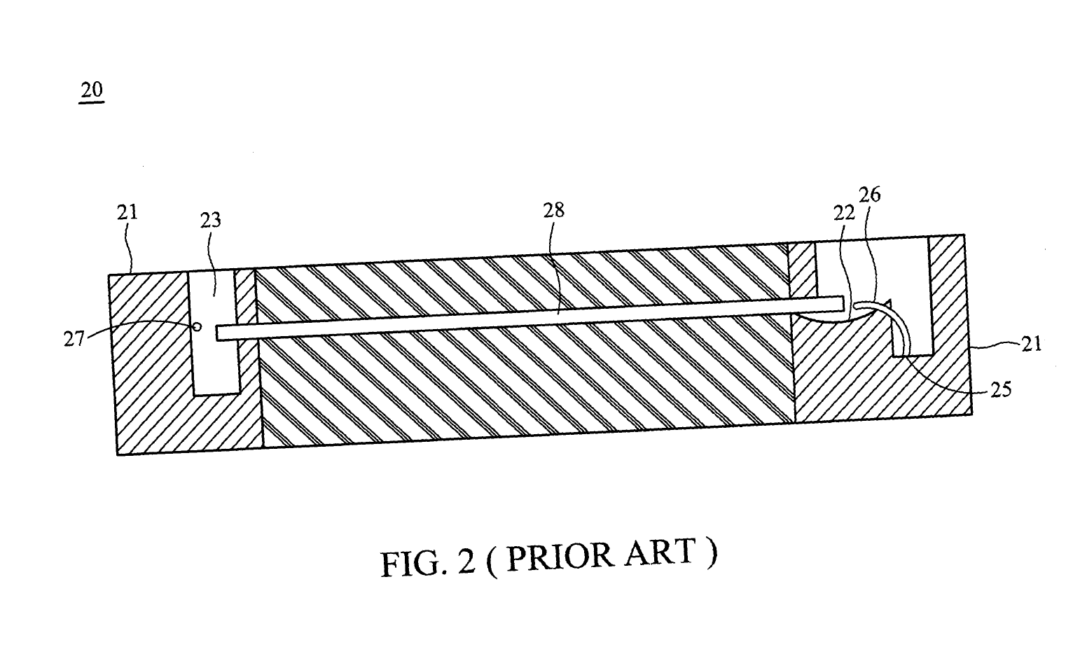

### DETAILED DESCRIPTION OF THE INVENTION

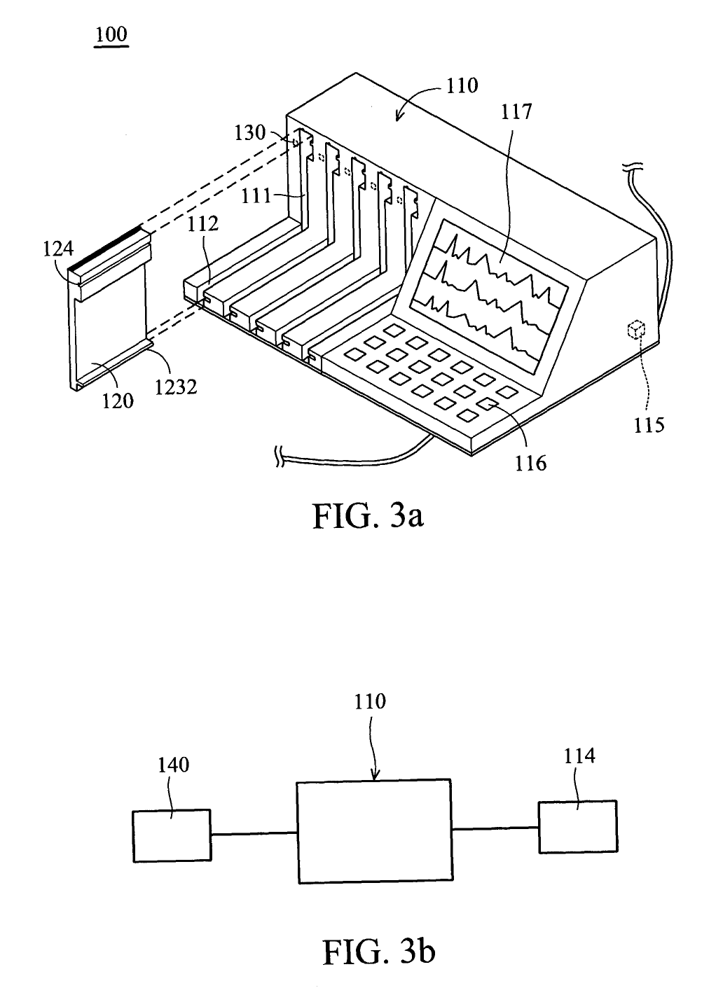

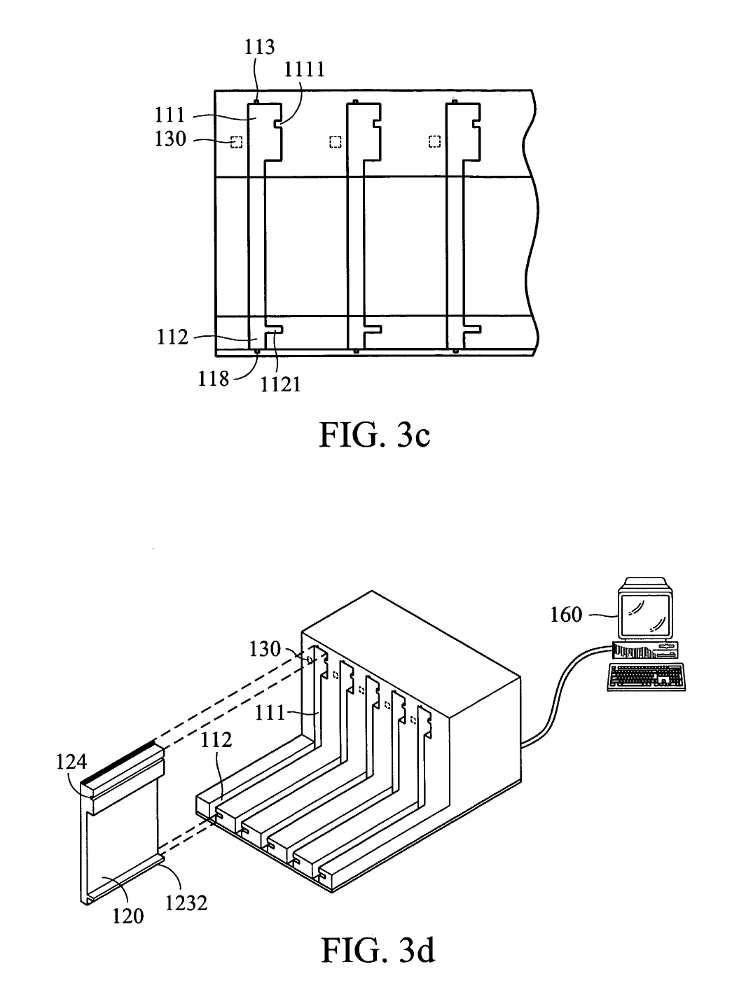

Referring to FIG. 3a, FIG. 3b, and FIG. 3c, an electrophoresis separation apparatus 100 as disclosed in this invention is used to detect samples, such as nucleic acid fragment and protein, in molecular biology analyses. The apparatus 100 comprises a main portion 110, a plurality of cartridges 120, a plurality of sensors 130, and a robot arm 140. It is noted that only one cartridge 120 is shown in FIG. 3a.

As shown in FIG. 3a, FIG. 3b, and FIG. 3c, the main portion 110 controls the detection of the samples, and includes a plurality of receiving portions 111, a plurality of slots 112, a plurality of first conductive portions 113, a plurality of second conductive portions 118, a power supply 114, a controller 115, an input panel 116, and a display 117.

Each of the receiving portions 111 receives the cartridge 120 to be disposed therein respectively. The main portion 110 further includes a plurality of second protrusions 1111 in the receiving portions 111. As shown in FIG. 3a, each of the second protrusions 1111 is formed in the receiving portion 111 respectively. Each of the slots 112 communicates with the receiving portion 111 respectively, and assists the cartridge 120 in moving into the receiving portion 111 of the main portion 110. The main portion 110 defines a plurality of first concave portions 1121 in the slot 112 respectively, and each of the first concave portions 1121 communicates with the corresponding slot 112.

Each of the first conductive portions 113 and each of the second conductive portions 118 are disposed in the receiving portion 111 respectively. The first conductive portions 113 and the second conductive portions 118 may be cylindrical; however, their shape is not limited as long as the first conductive portions 113 and the second conductive portions 118 can be coupled to conductive portions of the cartridges 120. In addition, as shown in FIG. 3c, the first conductive portion 113 is located at the top surface of the receiving portion 111, and the second conductive portion 118 is located at the bottom surface of the receiving portion 111. However, the first conductive portions 113 and the second conductive portions 118 may be located at side surfaces of the receiving portions 111; that is, their position is not limited as long as the first conductive portions 113 and the second conductive portions 118 can be coupled to the conductive portions of the cartridges 120.

The power supply 114 is coupled to the first conductive portion 113 and the second conductive portion 118, and provides voltage to the detection column 120 disposed in the receiving portion 111 via the first conductive portion 113 and the second conductive portion 118. The controller 115 is coupled to the power supply 114 to actuate the power supply 114 to provide the voltage. The input panel 116 is coupled to the controller 115, for the user to input data to be analyzed. The display 117 is coupled to the controller 115, and displays the data.

It is understood that a computer 117 can replace the controller 115, the input panel 116, and the display 117 as shown in FIG. 3d. Specifically, the functions of the controller 115, the input panel 116, and the display 117 can be performed by the computer 160.

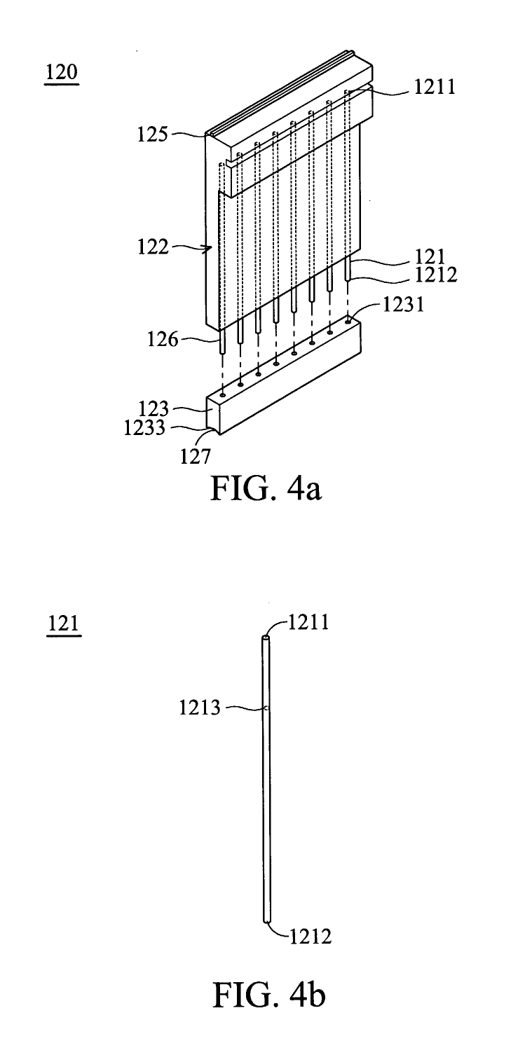

Referring to FIG. 3a, the cartridge 120 is disposed in the receiving portion 111 of the main portion 110 in a detachable manner. As shown in FIG. 4a, the cartridge 120 includes a plurality of detection columns 121, a body 122, a base 123, a third conductive portion 125, and a fourth conductive portion 127.

The detection column 121 is disposed in the body 122, and includes a first end 1211 and a second end 1212 as shown in FIG. 4b. The sample is attached to the second end 1212 of the detection column 121 by direct dipping. The detection column 121 includes a convex lens 1213 therein at the first end 1211 to assist the sensor 130 in detecting the sample.

The base 123 is combined with the body 122, and includes a plurality of holes 1231 for receiving the detection columns 121 of the body 122.

Each of the third conductive portions 125 corresponds to the first conductive portion 113 of the main portion 110, and each of the fourth conductive portions 127 corresponds to the second conductive portion 118 of the main portion 110. The third conductive portions 125 and the fourth conductive portions 127 may be shaped like a cylinder; however, their shape is not limited as long as the third conductive portions 125 and the fourth conductive portions 127 can be coupled to the first conductive portions 113 and the second conductive portions 118 of the main portion 110. In addition, the third conductive portion 125 is located at the top surface of the cartridge 120, and the fourth conductive portion 127 is located at the bottom surface of the cartridge 120. However, the third conductive portions 125 and the fourth conductive portions 127 may be located at side surfaces of the cartridge 120; that is, their position is not limited as long as the third conductive portions 125 and the fourth conductive portions 127 can be coupled to the first conductive portions 113 and the second conductive portions 118 of the main portion 110. Thus, when the cartridge 120 is disposed in the receiving portion 111 of the main portion 110, the third conductive portions 125 of the cartridge 120 are coupled to the first conductive portion 113 of the main portion 110, and the fourth conductive portions 127 of the cartridge 120 are coupled to the second conductive portion 118 of the main portion 110. The power supply 114 of the main portion 110 provides the voltage to the cartridge 120 so that the detection column 121 of the cartridge 120 has a first voltage at the first end 1211 and a second voltage at the second end 1212. As a result, the sample moves from the second end 1212 to the first end 1211 through the detection column 121 by a voltage differential between the first voltage and the second voltage.

The cartridge 120 includes a first protrusion 1232 corresponding to the first concave portion 1121 of the main portion 110. The cartridge 120 can move smoothly in the slot 112 of the main portion 110 by the first protrusion 1232 insertion into the first concave portion 1121. In addition, the cartridge 120 defines a second concave portion 124 corresponding to the second protrusion 1111 of the main portion 110. The cartridge 120 can move smoothly in the receiving portion 111 of the main portion 110 by the second protrusion 1111 insertion into the second concave portion 124.

It is noted that since the protrusions and the concave portions are simply used for the cartridge 120 to move smoothly in the main portion 110, they can have different forms. For example, the concave portion and the corresponding protrusion can be switched, or other guiding members can be used.

Furthermore, referring to FIG. 4a, the cartridge 120 includes a standard column 126 for comparison with the detection column 121. However, the standard column 126 may be omitted when the reference data is pre-stored in the main portion 110.

It is understood that the macromolecular material added into the detection column 121 to separate the sample can be natural or artificial.

It is also understood that a liquid, gel, or solid material can be added into the detection column to separate the sample. The solid material may be porous.

As shown in FIG. 3c, the sensors 130 are disposed in the receiving portions 111 of the main portion 110 respectively, and detect a movement of the sample in the detection column 121 of the cartridge 120. Furthermore, the sensor 130 may be an optical sensor, such as a photodiode or a PMT.

In addition, a labeling reagent can be attached to the sample to assist the sensor 130 in detecting the sample. The labeling reagent comprises fluorescent molecules, nanometer-scale particles, or light-absorbent molecules.

Referring to FIG. 3b, the robot arm 140 is coupled to the main portion 110, and moves the cartridge 120 to a predetermined position. It is understood that the robot arm 140 is adapted in situations requiring numerous analyses. For fewer analyses, the cartridge 120 can be moved manually without the robot arm 140.

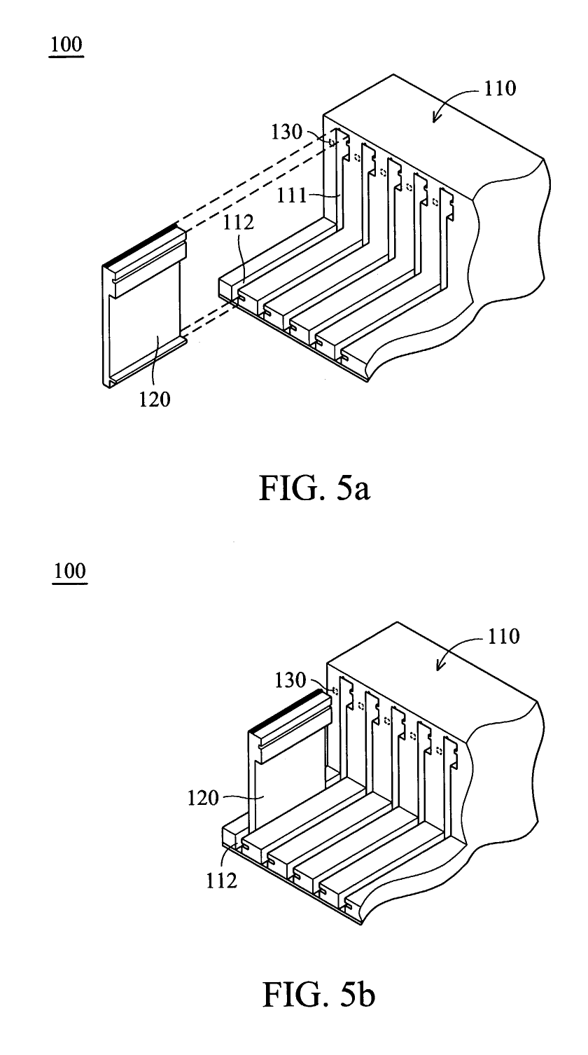

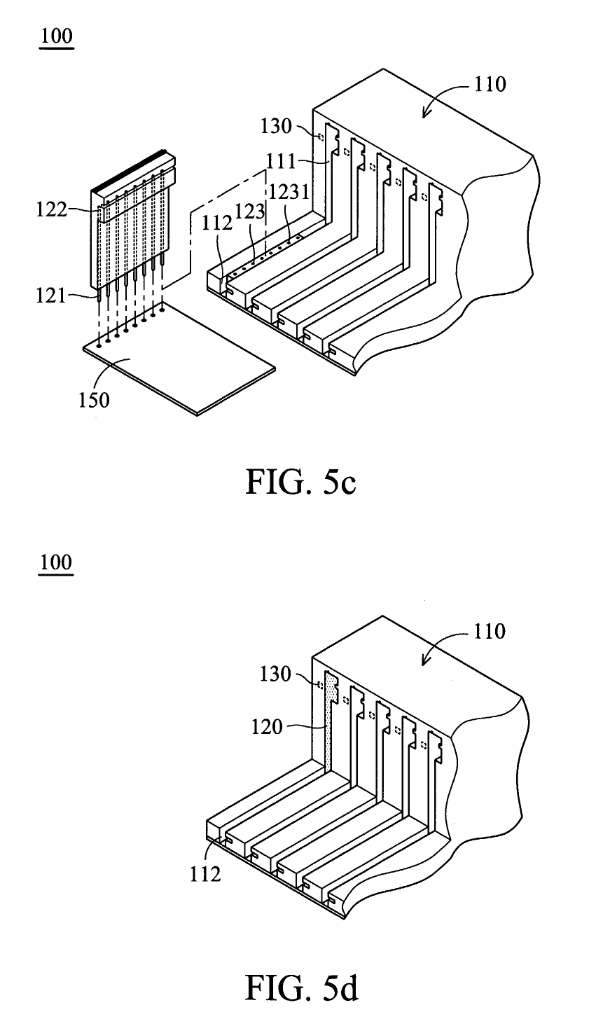

FIG. 5a, FIG. 5b, FIG. 5c and FIG. 5d are schematic views that show the electrophoresis separation apparatus, shown in FIG. 3a, performing detection of the samples.

As shown in FIG. 5a, the cartridge 120 is first aligned with the slot 112 of the main portion 110, and the cartridge 120 is inserted into the slot 112 of the main portion 110 as shown in FIG. 5b. Then, the body 122 of the cartridge 120 is separated from the base 123 to leave the base 123 in the slot 112. The detection columns 121 in the body 122 of the cartridge 120 are directly dipped into wells of a sample plate 150 so that the samples are attached to the second ends 1212 of the detection columns 121 as shown in FIG. 5c. Sequentially, the body 122 with the samples is combined with base 123 again, and the combined cartridge 120 is inserted into the receiving portion 111 of the main portion 110 as shown in FIG. 5d. The power supply 114 of the main portion 110 is switched on, and the sensor 130 starts to detect to complete the analysis. After the analysis, the cartridge 120 is ejected from the main portion 110, and the body 122 is discarded with the base 123.

As stated above, since the detection column is disposed in the separable cartridge in the invention, the operation of the electrophoresis separation apparatus is not restrained by the position of the main portion, the detection of the apparatus is thus simpler and faster. As well, since the sample can be directly attached on the detection columns of the cartridge, there is no intermediate device for sampling like the conventional electrophoresis separation apparatus.

Furthermore, since the detection column is disposed in the cartridge in a replaceable manner, the samples attached to the cartridge can be prevented from intermixing.

In addition, the material for separating the sample can be previously filled in the detection column of the cartridge. Thus, the separation process can be performed better.

Furthermore, since the sensor is built in the main portion, the relationship between the sensor and the detection column can be precisely set without adjustment.

Furthermore, in situations requiring numerous analyses, instead of manual operation, the robot arm can handle the cartridge to automatically perform the movement.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiments, those alternatives which have been discussed above, and all equivalents thereto.

What is claimed is:

1. An electrophoresis separation apparatus for detecting samples, comprising:
a main portion, including a receiving portion, for controlling the detection of the samples;
a cartridge, disposed in the receiving portion of the main portion in a detachable manner, including a detection column, wherein the detection column includes a first end and a second end, and has a first voltage at the first end and a second voltage at the second end, and the sample is attached to the second end of the detection column, whereby the sample moves from the second end to the first end through the detection column by a voltage differential between the first voltage and the second voltage; and
a sensor, disposed in the main portion, for detecting a movement of the sample in the detection column.

2. The electrophoresis separation apparatus as claimed in claim 1, wherein the cartridge further comprises:
a body including the detection column for attaching the sample; and
a base, combined with the body, including a hole for receiving the detection column of the body.

3. The electrophoresis separation apparatus as claimed in claim 1, wherein the main portion defines a slot communicating with the receiving portion to guide the cartridge into the receiving portion.

4. The electrophoresis separation apparatus as claimed in claim 3, wherein the main portion defines a first concave portion communicating with the slot, and the cartridge includes a first protrusion corresponding to the first concave portion, whereby the cartridge moves smoothly in the slot by the first protrusion's insertion into the first concave portion.

5. The electrophoresis separation apparatus as claimed in claim 1, wherein the main portion includes a second protrusion in the receiving portion, and the cartridge defines a second concave portion corresponding to the second protrusion, whereby the cartridge moves smoothly in the receiving portion by the second protrusion's insertion into the second concave portion.

6. The electrophoresis separation apparatus as claimed in claim 1, wherein the main portion includes a first conductive portion and a second conductive portion in the receiving portion, and the cartridge includes a third conductive portion corresponding to the first conductive portion, and a fourth conductive portion corresponding to the second conductive portion, whereby the third conductive portion is coupled to the first conductive portion, and the fourth conductive portion is coupled to the second conductive portion so that the detection column has the first voltage and the second voltage.

7. The electrophoresis separation apparatus as claimed in claim 6, wherein the main portion further comprises:
a power supply, coupled to the first conductive portion and the second conductive portion, for providing the first voltage and the second voltage to the detection column via the first conductive portion and the second conductive portion; and
a controller coupled to the power supply to control the power supply.

8. The electrophoresis separation apparatus as claimed in claim 7, wherein the main portion further comprises:
an input panel, coupled to the controller, for inputting data to be analyzed; and
a display, coupled to the controller, for displaying the data.

9. The electrophoresis separation apparatus as claimed in claim 1, further comprising:
a power supply, coupled to the main portion, for providing the first voltage and the second voltage to the detection column; and
a computer, coupled to the main portion, for controlling the power supply and inputting and displaying data to be analyzed.

10. The electrophoresis separation apparatus as claimed in claim 1, further comprising:
a robot arm, coupled to the main portion, for moving the cartridge to a predetermined position.

11. The electrophoresis separation apparatus as claimed in claim 1, wherein the cartridge includes a standard column for comparison with the detection column.

12. The electrophoresis separation apparatus as claimed in claim 1, wherein a macromolecular material is added into the detection column to separate the sample.

13. The electrophoresis separation apparatus as claimed in claim 12, wherein the macromolecular material is natural or artificial.

14. The electrophoresis separation apparatus as claimed in claim 1, wherein a liquid is added into the detection column to separate the sample.

15. The electrophoresis separation apparatus as claimed in claim 1, wherein a gel is added into the detection column to separate the sample.

16. The electrophoresis separation apparatus as claimed in claim 1, wherein a solid material is added into the detection column to separate the sample, and the solid material is porous.

17. The electrophoresis separation apparatus as claimed in claim 1, wherein the sensor is an optical sensor.

18. The electrophoresis separation apparatus as claimed in claim 17, wherein the sensor comprises a photodiode corresponding to the receiving portion.

19. The electrophoresis separation apparatus as claimed in claim 17, wherein the sensor comprises a PMT corresponding to the receiving portion.

20. The electrophoresis separation apparatus as claimed in claim 1, wherein a labeling reagent is attached to the sample to assist the sensor in detecting the sample.

21. The electrophoresis separation apparatus as claimed in claim 20, wherein the labeling reagent comprises fluorescent molecules, nanometer-scale particles, or light-absorbent molecules.

22. The electrophoresis separation apparatus as claimed in claim 1, wherein the detection column includes a convex lens therein to assist the sensor in detecting the sample.
